(19) United States
(12) Patent Application Publication
(10) Pub. No.: US 2021/0330088 A1
(43) Pub. Date: Oct. 28, 2021

(54) Removable Seat Partition and/or Seat Blocker

(71) Applicant: Aerofoam Industries, Inc., Lake Elsinore, CA (US)

(72) Inventors: Noel Castellon,, SR., Murrieta, CA (US); James Barrett, Murrieta, CA (US); Kai Bell, Murrieta, CA (US); Jon Sherk, Lake Elsinore, CA (US); Julio S. Mendoza, Ontario, CA (US); Nathan Barrett, Murrieta, CA (US); Edgar Martinez, Lake Elsinore, CA (US)

(21) Appl. No.: 17/243,511

(22) Filed: Apr. 28, 2021

Related U.S. Application Data
(60) Provisional application No. 63/016,808, filed on Apr. 28, 2020.

(51) Int. Cl. A47C 7/62

(52) U.S. Cl. CPC A47C 7/62

(57) ABSTRACT

A removable seat partition and/or seat blocker allows reconfiguration of any combination of seats to provide a barrier between seated persons and/or block or inhibit use of a seat to promote social distancing. The removable seat partition and/or blocker may be used on an aircraft seat, and/or on a seat in other modes of transportation, including but not limited to buses, subways, trains, etc., and/or on a seat in restaurants, bars, movie theaters, or any other public setting with seating.

### FIELD OF THE DISCLOSURE

The present disclosure generally relates to a removable seat partition and/or a seat blocker.

### BACKGROUND OF THE DISCLOSURE

Social distancing is used to inhibit or decrease the spread of community-acquired infections, such as viral infections. In response to social distancing recommendations, commercial airline operators, for example, may not allow passengers to occupy specific seats, such as middle row seats, on their aircraft. This has left airline operators with an empty, inoperable seat that provides no utility to the passengers.

### SUMMARY OF THE DISCLOSURE

In one aspect, a removable seat partition, constructed according to the teachings of the present disclosure, allows reconfiguration of any combination of seats to provide a barrier between seated persons and promote social distancing. For example, the removable seat partition may be configured to be used on an aircraft seat. In other embodiments, the removable seat partition may be configured to be used on seats in other modes of transportation, including but not limited to buses, subways, trains, etc. In yet other embodiments, the removable seat partition may be configured to be used on seats in restaurants, bars, movie theaters, or any other public setting with seating.

In another aspect, a removable seat blocker, constructed according to the teachings of the present disclosure, allows reconfiguration of any combination of seats to block or inhibit use of a seat, such as a middle seat between two other seats, and provide a barrier and promote social distancing. For example, the removable seat blocker may be configured to be used on an aircraft seat. In other embodiments, the removable seat blocker may be configured to be used on seats in other modes of transportation, including but not limited to buses, subways, trains, etc. In yet other embodiments, the removable seat blocker may be configured to be used on seats in restaurants, bars, movie theaters, or any other public setting with seating.

### BRIEF DESCRIPTION OF THE DRAWINGS

FIG. 1 is a rear perspective of an illustrated embodiment of a removable seat partition, including a base usable as a seat blocker and a partition coupled to the base;

FIG. 2 is a side elevational view of the removable seat partition;

FIG. 3 is a front elevational view of the removable seat partition;

FIG. 4 is an exploded view of the removable seat partition;

FIG. 5 is a perspective view of three aircraft seats and the removable seat partition coupled to the middle seat; and

FIG. 6 is an enlarged, partial view of FIG. 5.

### DETAILED DESCRIPTION OF THE DISCLOSURE

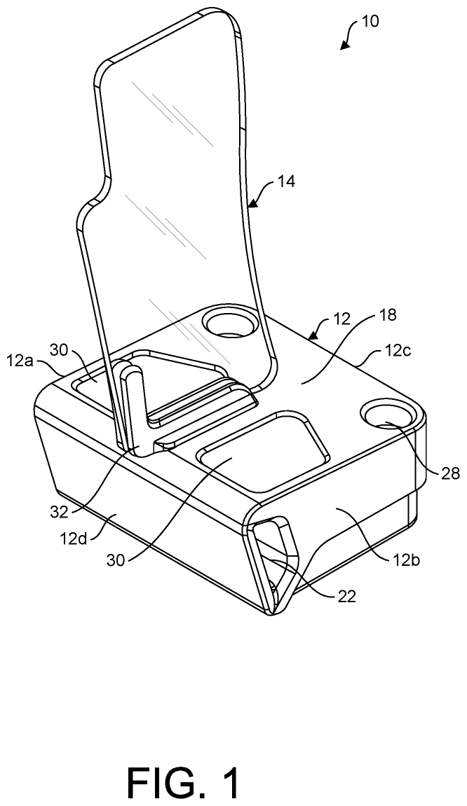

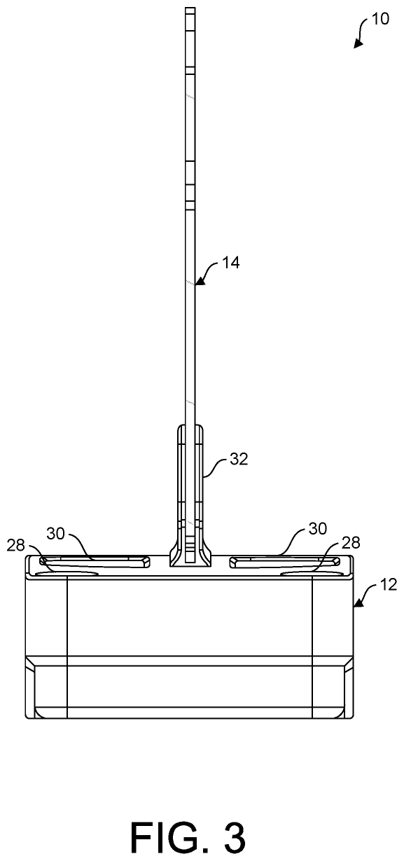

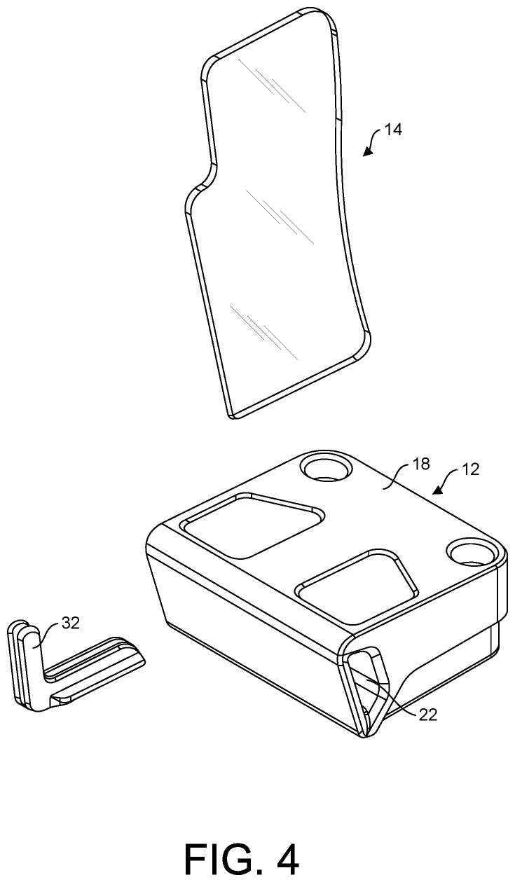

Referring to FIGS. 1-6, one embodiment of a removable seat partition, constructed according to the teachings of the present disclosure, is generally indicated at reference numeral 10. The illustrated seat partition 10 is configured to be used on passenger seating in an aircraft, and in particular, a commercial aircraft. It is understood that in other embodiments, the seat partition may be used for seating in other public settings, including but not limited to buses, subways, trains, restaurants, bars, movie theaters, or any other public setting with seating. The seat partition is configured to be coupled to an existing seat. In one example, the seat partition is employed without reconfiguring the existing seat or modifying the structure of the seat. The seat partition is also configured to be readily removable from the seat, such as when social distancing is not desired or necessary or for cleaning (e.g., disinfecting or sterilization) purposes.

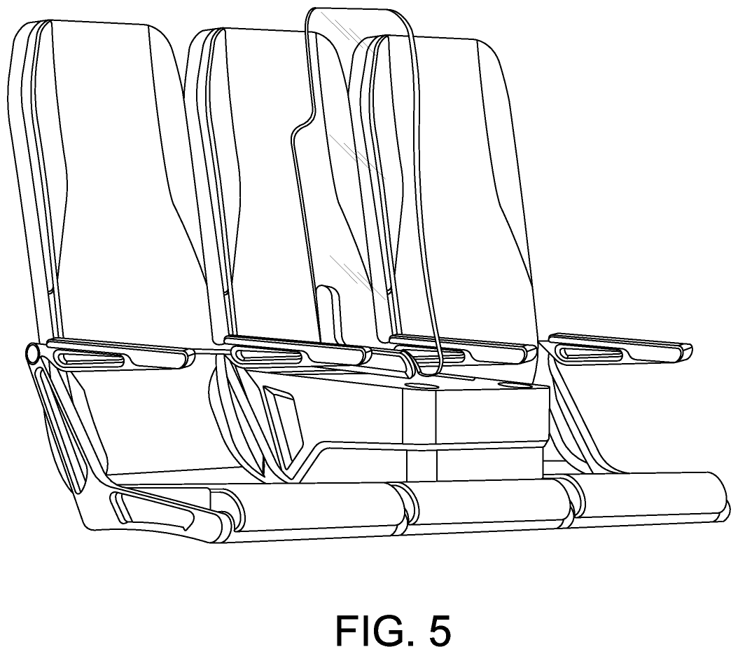

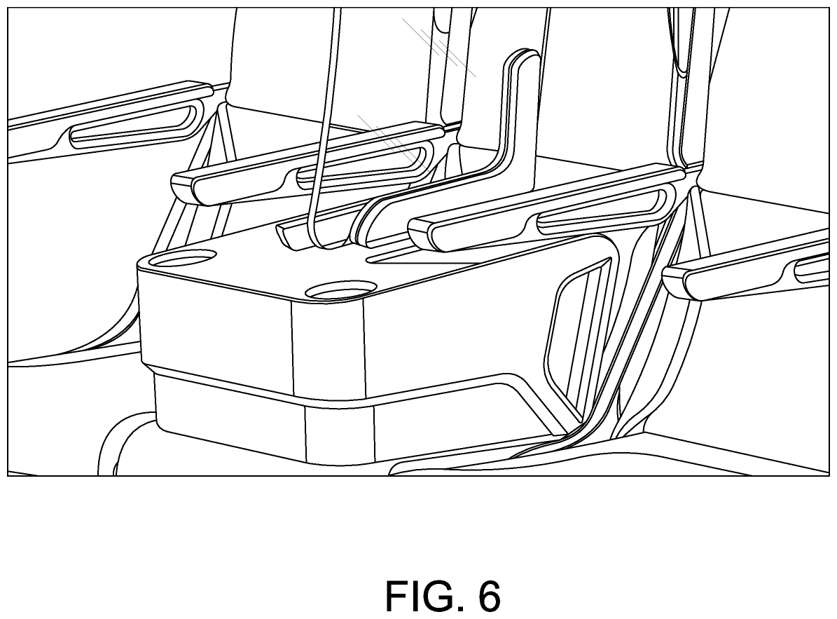

The illustrated seat partition 10 generally comprises base, generally indicated at 12, and a vertical panel, generally indicated at 14, extending upward from the base. In general, the base 12 is sized and shaped to rest on an individual seat cushion on the aircraft, and the vertical panel 14 is sized and shaped to extend generally along the height of the corresponding seat back so that an upper end of the vertical panel may be adjacent to the upper end of the seat back. In this way, the seat partition 10 provides a physical barrier between passengers on either side of the partition. As an example, the seat partition 10 may be coupled to a middle seat disposed between two side seats, such that the partition provides a barrier between the two side seats, such as shown in FIGS. 5 and 6. In one or more embodiments, only the base 12 may be used, such that the vertical panel 14 is omitted. In this embodiment, the base 12 is used as a seat blocker to block or inhibit use of a seat, such as a middle seat between two other seats, and promote social distancing.

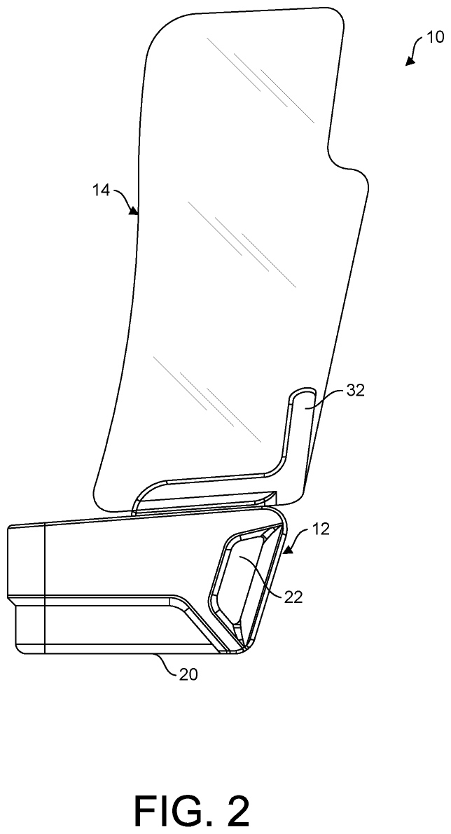

The base 12 (or blocker) may have a generally rectangular footprint. A maximum height of the base 12 extends from an upper surface 18 to a lower surface 20 (FIG. 2) of the base and may be about twice the height of the seat cushion. In one example, the height may be from about 4 in to about 12 in, and in one example, about 8 in. A maximum width of the base extends between opposite sides 12a, 12b of the base and is configured to allow the base 12 to fit between adjacent armrests. The maximum width of the base may be from about 14 in to about 21 in, and in one example, about 16 in. A maximum depth of the base 12 extends between front and back ends, 12c, 12d, respectively, of the base and may be configured to extend a depth of the seat cushion (e.g., from about 13 in to about 18 in, such as 14 in). In one example, the depth is configured so that the front end 12c of base 12 does not extend beyond the front end of the seat cushion when the base is disposed on the seat cushion. The back end 12d of the illustrated base 12 is beveled from the upper surface 18 to the lower surface 20 to correspond generally to the angle between the seat back and the seat cushion. In one example, the footprint of the lower surface 20 of the base 20 is sized and shaped such that it covers at least about 70%, or at least about 75%, or at least about 80%, or at least about 85%, or at least about 90%, or at least about 95%, or substantially the entirety of the upper surface of the seat cushion, such as an airplane seat or other passenger or customer seat.

The illustrated base 12 (or blocker) defines a coupling opening 22 (broadly, a coupling component) configured to receive a coupler (a strap, for example) to couple the base (and the partition 10) to the seat. The illustrated coupling opening 22 is configured to receive a strap of a seatbelt of the seat therethrough and allow the seat belt to be fastened to couple the base 12 to the seat. The opening 22 extends through the opposite sides 12a, 12b of the base 12 adjacent the back end 12c thereof. The opening 22 may be of other configurations suitable for coupling the base to the seat. Moreover, the base may include other structures for use in coupling the partition to the seat. For example, the base may be configured to be coupled to the seat using seat belt shackles, hook and loop fasteners, or other tensioning or strapping methods. The base may be configured to couple to one or more armrests or other structures of the seat.

The base 12 may include one or more accessory features for use by passengers on either side of the partition 10. The illustrated base defines cup holders 28 on other side of the panel 14. The illustrated cup holders 28 are defined by the upper surface 18. The upper surface 18 may also define additional receptacles or cavities 30 for holding other passengers' items, such as mobile phones, wallets, etc. The base 12 may include other accessories, such as slide out tablet stands or power receptacles (not shown). The base 12 may be formed from plastic or other material. The base 12 can be manufactured with standard machining, standard thermoforming, and standard upholstery methods. Other methods may include injection molding and composite manufacturing.

The vertical panel 14 may be removably coupled to the base 12, such that the partition may be configured as a seat blocker, for example. In the illustrated embodiment, the vertical panel is selectively coupled to a panel bracket 32, which is coupled to the base 12 (e.g., the upper surface 18 of the base). The panel bracket 32 may be omitted on one or more embodiments. The illustrated bracket 32 is generally L-shaped and defines a slot 34 extending from a back end toward a front end of the bracket. The bracket 32 may be disposed in a middle plane midway between the two sides 12a, 12b of the base 12. The ability to remove the panel 14 is convenient when flying with loved ones, business associates, or other relations. The vertical panel 14 may be removably coupled to the bracket 32, such as by a detent mechanism, a snap-fit coupling, a friction-fit connection, or in other ways. The bracket 32 may be removably or non- removably coupled to the base 12, such as by a releasable snap-fit connection or other releasable connection. The bracket 32 may be formed from plastic, metal (e.g., aluminum), or other material.

In one example, the panel 14 may be substantially transparent, translucent or opaque. The panel 14 may be rigid, semi-rigid, or generally flexible. The panel may be formed from plastic or other material. The panel 14 may be configured to be cleaned (e.g., disinfected or sterilized). In one example, the panel 14 may comprise (e.g., formed from) acrylic. The panel 14 may be free from openings. In the illustrated embodiment, a back end of the panel 14 is contoured to accommodate a head rest of the seat back. A front end of the panel 14 may be concave or other shapes. Corners of the panel 14 may be radiused or rounded for safety. In one example, the panel has a width (or thickness) extending between opposite side faces (e.g., generally planar side faces) that is from about 0.125 in to about 1 in, and in one example, about 0.1875 in. In one example, the ratio of the maximum width of the base 12 to the width of the panel 14 is about 50:1 or about 45:1 or about 40:1 or about 35:1 or about 30:1 or about 25:1 or about 20:1 or about 15:1 or about 10:1. Thus, the panel 14 is relatively thin compared to the base 12 to allow for more space for passenger's arm and bodies. A depth of the panel 14 may be less than the maximum depth of the base 12 such that the front end of the panel does not overhang or extend beyond the upper surface of the base 12. The panel 14 can be manufactured with standard machining, standard thermoforming, and standard upholstery methods. Other methods may include injection molding and composite manufacturing.

Modifications and variations of the disclosed embodiments are possible without departing from the scope of the invention defined in the appended claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A removable seat partition comprising:
a base sized and shaped to rest on a seat cushion of an individual seat, wherein the base is configured to be removably coupled to the seat cushion;
a vertical panel coupled to the base, wherein the vertical panel is configured to extend generally along a height of a seat back of the individual seat.

2. The removable seat partition set forth in claim 1, wherein the vertical panel is removably coupled to the base.

3. The removable seat partition set forth in claim 1, wherein the vertical panel is removably coupled to the base by at least one of a snap-fit connection and a friction-fit connection.

4. The removable seat partition set forth in claim 1, further comprising a bracket coupled to the base and the vertical panel to couple the vertical panel to the base.

5. The removable seat partition set forth in claim 4, wherein the vertical panel is removably coupled to the bracket.

6. The removable seat partition set forth in claim 1, wherein the vertical panel is configured such that an upper end of the vertical barrier is be adjacent to an upper end of the seat back when the removable seat partition is coupled to the seat.

7. The removable seat partition set forth in claim 1, wherein the base is configured to receive a coupler to couple the base to the individual seat.

8. The removable seat partition set forth in claim 1, wherein the base defines a coupling opening configured to receive a strap coupled to the seat for coupling the base to the seat.

9. The removable seat partition set forth in claim 1, wherein the base defines a coupling opening configured to receive a seatbelt coupled to the seat for coupling the base to the seat.

10. The removable seat partition set forth in claim 9, wherein the coupling opening extends through opposite sides of the base adjacent a back end of the base.

11. The removable seat partition set forth in claim 1, wherein the base includes one or more accessory features for use by persons on either side of the partition.

12. The removable seat partition set forth in claim 11, wherein the one or more accessory features comprises cup holders defined by an upper surface of the base.

13. The removable seat partition set forth in claim 11, wherein the one or more accessory features comprises receptacles for holding personal items.

14. The removable seat partition set forth in claim 1, wherein the vertical panel comprises one of substantially transparent and translucent material.

15. The removable seat partition set forth in claim 1, wherein a back end at an upper end of the vertical panel is contoured to accommodate a head rest of a seat back of the seat.

16. A method of installing the removable seat partition set forth in claim 1, the method comprising:
resting the base on a seat cushion of a middle seat of an aircraft; and
removably coupling the base of the seat partition to the seat.

17. A method of installing the removable seat partition set forth in claim 9, the method comprising:
resting the base on a seat cushion of a middle seat of an aircraft;
inserting a strap of a seat belt through the coupling opening; and
fastening the seat belt to couple the base to the seat.

18. A removable seat blocker comprising:
a base sized and shaped to rest on a seat cushion of an individual seat of an aircraft,
wherein the base is configured to be removably coupled to the seat cushion,
wherein the base has a generally rectangular lower surface having a footprint sized and shaped that it covers at least about 70% of an upper surface of the seat cushion.

19. The removable seat blocker set forth in claim 18, wherein the base has a back end that is beveled from an upper surface to the lower surface of the base to correspond generally to the angle between a seat back and the seat cushion of the seat.

20. The removable seat blocker set forth in claim 18, wherein the base includes cup holders defined by the upper surface of the base.
